(19) United States
(12) Patent Application Publication
(10) Pub. No.: US 2026/0168566 A1
(43) Pub. Date: Jun. 18, 2026

(54) MODULAR HYBRID TRANSMISSION SECONDARY STATOR COOLING

(71) Applicant: Schaeffler Technologies AG & Co. KG, Herzogenaurach (DE)

(72) Inventor: Drew Hilty, Wooster, OH (US)

(73) Assignee: Schaeffler Technologies AG & Co. KG, Herzogenaurach (DE)

(21) Appl. No.: 18/985,360

(22) Filed: Dec. 18, 2024

(51) Int. Cl. F16H 41/30; B60K 6/38; B60K 11/02

(52) U.S. Cl. CPC F16H 41/30; B60K 6/38; B60K 11/02

(57) ABSTRACT

A modular hybrid transmission including a valve configured to direct fluid from a torque converter of the modular hybrid transmission to an electric motor of the modular hybrid transmission when pressure inside of the torque converter exceeds a threshold value. The threshold value typically corresponds to an upper range of torque converter operating pressure coincident with peak electric motor operation.

### TECHNICAL FIELD

The present disclosure relates generally to modular hybrid transmissions, and more specifically, to a cooling arrangement for a modular hybrid transmission.

### BACKGROUND

In general, modular hybrid transmissions are known structures used in hybrid vehicles. Modular hybrid transmissions (MHTs) include an electric motor (emotor) integrated into a typical drivetrain including an internal combustion engine and a torque converter. The internal combustion engine can be engaged and disengaged using an emotor clutch (commonly known as the KO clutch) in order to operate in an hybrid mode where the emotor and internal combustion engine are connected to the transmission input shaft in order to provide the motive force through the driveline to the vehicle wheels.

Cooling of the emotor is typically conducted by circulating fluid (oil) through and around the stator and/or rotor and dissipating the heat via a heat exchanger to the environment. In a typical MHT, the KO clutch supplies fluid to the emotor for cooling. During periods of peak and/or extended emotor use, the primary cooling system of the emotor can be overwhelmed and the emotor stator can experience higher temperatures than desired. Under such conditions, the emotor output is generally decreased to reduce temperatures. This leads to a temporary decrease in performance of the MHT.

### SUMMARY

Embodiments according to this disclosure provide additional cooling capacity to the emotor of a MHT during peak operations. In one embodiment, a valve is configured to direct fluid from the torque converter of the MHT to the emotor when pressure inside the torque converter exceeds a threshold value. The threshold value typically corresponds to an upper range of torque converter operating pressure coincident with peak emotor operation.

In accordance with one aspect, a modular hybrid transmission comprises an electric motor, and a torque converter driven by the electric motor. The torque converter includes a housing and a pump, and the housing of the torque converter includes a valve for selectively restricting or allowing a flow of fluid from the torque converter to the electric motor.

The valve can include a reed valve. The reed valve can be configured to open when a pressure inside the torque converter exceeds a threshold value. The threshold value can be within 30% of a maximum torque converter pressure, for example. The fluid can be directed to a stator of the electric motor. The valve can define a flow passage extending at an oblique angle with respect to a rotational axis of the torque converter. The housing can include a torque converter cover, and the valve restricts or allows the flow of fluid through the torque converter cover.

In accordance with another aspect, a torque converter for a modular hybrid transmission comprises a housing and a pump configured to be driven by an electric motor, the housing of the torque converter includes a valve for selectively restricting or allowing a flow of fluid from the pump to the electric motor.

The valve can include a reed valve. The reed valve can be configured to open when a pressure inside the torque converter exceeds a threshold value. The threshold value can be within 30% of a maximum torque converter pressure, for example. The valve can define a flow passage extending at an oblique angle with respect to a rotational axis of the torque converter. The housing can include a torque converter cover, and the valve restricts or allows the flow of fluid through the torque converter cover.

In accordance with another aspect, a method of cooling an electric motor of a modular hybrid transmission comprises providing a modular hybrid transmission comprising: an electric motor, a torque converter driven by the electric motor, the torque converter including a housing and a pump; and the housing of the torque converter includes a valve for selectively restricting or allowing a flow of fluid from the torque converter to the electric motor, operating the modular hybrid transmission to generate fluid pressure in the torque converter, and supplying fluid from the torque converter to the electric motor via the valve based at least in part on an operational characteristic of the modular hybrid transmission.

The operational characteristic can include a fluid pressure within the torque converter. The valve can include a reed valve configured to open when the pressure in the torque converter exceeds a threshold value. The threshold value can be within 30% of a maximum torque converter pressure, for example. The method can include directing the fluid to a stator of the electric motor. The valve can define a flow passage extending at an oblique angle with respect to a rotational axis of the torque converter. The housing can include a torque converter cover, and the valve restricts or allows the flow of fluid through the torque converter cover.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of a MHT in accordance with the present disclosure.

FIG. 2 is an enlarged portion of FIG. 1 showing a reed valve in a closed position in accordance with the present disclosure.

FIG. 3 is an enlarged portion of FIG. 1 showing a reed valve in a closed position in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

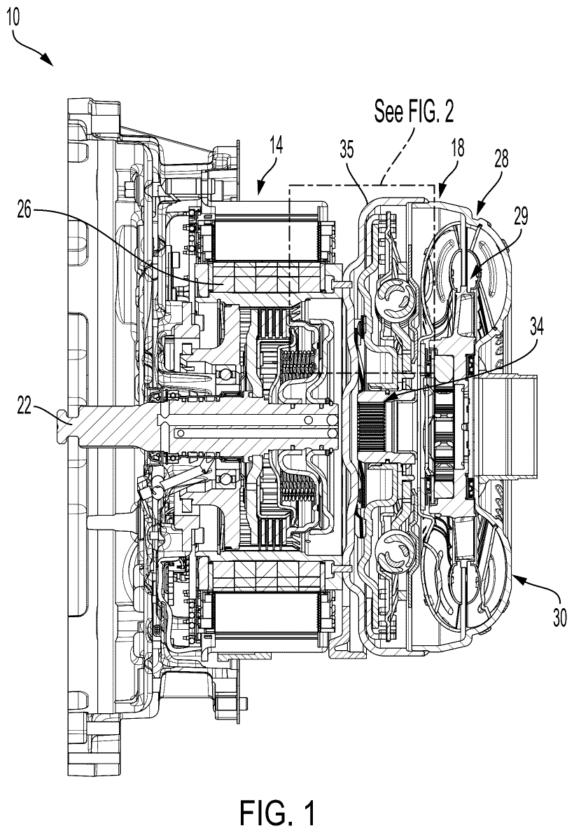

Referring to FIG. 1, an MHT in accordance with the present disclosure is illustrated and identified generally by reference numeral 10. The MHT 10 includes an electric motor 14 and a torque converter 18. A crankshaft 22 of an internal combustion engine along with a rotor 26 of the electric motor 14 are coupled to the torque converter 18 for supplying torque thereto.

The torque converter 18 includes, among other things, a pump 28 and a torque converter cover 35. Together, the pump 28 and the torque converter cover 35 define a housing of the torque converter 18. The pump 28 operates to circulate fluid within a chamber 29 of the torque converter 18 to hydraulically transmit energy to an output shaft 34 of the torque converter 18. As torque converters are well-known, further description of the internal features of the torque converter are not necessary. The MHT 10 is typically configured as a component of a customer assembly and, as such, the MHT 10 can be supported within a housing (not shown) of the customer assembly.

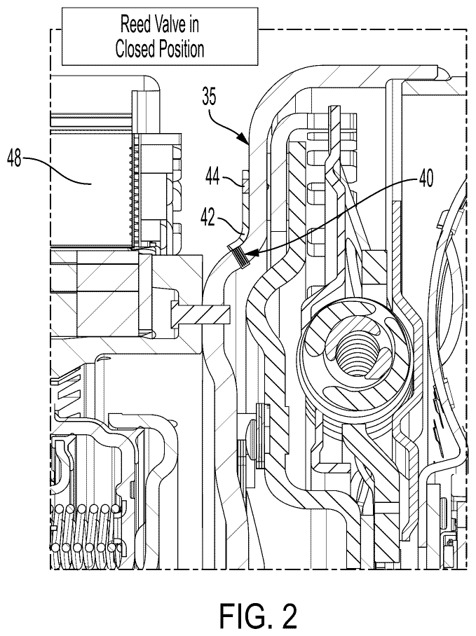

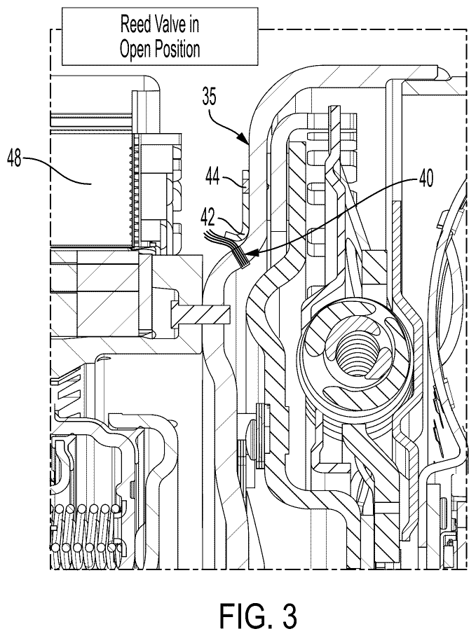

With additional reference to FIGS. 2 and 3, and in accordance with the present disclosure, the torque converter 18 includes a passageway 40 in the torque converter cover 35 and a reed valve 42 for directing pressurized fluid F to a stator 48 of the electric motor 14 during certain operating conditions. The reed valve 42 restricts or permits flow from the torque converter 18 through a passageway 40, as shown. In the illustrated example, the reed valve 42 is configured to open when a threshold fluid pressure is exceeded within the torque converter 18. This threshold pressure may typically be at or near a maximum pressure of the torque converter 18, or within, for example, 10-30 percent of the maximum pressure of the torque converter 18 during operation. Accordingly, fluid from the torque converter 18 is only directed to the stator 48 during situations under which the electric motor 14 is under peak operating conditions and, therefore, may require the additional cooling that the fluid from the torque converter 18 can provide. This is a passive arrangement where the additional cooling capacity is automatically supplied to the electric motor 14 as a function of the pressure of the fluid in the torque converter 18. In FIG. 3, the fluid is shown in schematic form being distributed to the electric motor 14 via the open reed valve 42. The passageway 40 defines a flow passage extending at an oblique angle with respect to a rotational axis of the torque converter 18. It should be appreciated, however, that the fluid can be distributed to the electric motor 14 via a fluid line and/or one or more nozzles for dispersing the fluid. In this illustrated example, the reed valve 42 is located in the torque converter cover and secured thereto by a weld 44. In other embodiments, the reed valve 42 can be located in other locations such as, for example, the pump 28 of the torque converter 18. In other embodiments, the fluid can be routed to an existing oil cooling circuit of the electric motor 14. After the fluid is distributed to the electric motor 14 it may drain to a sump of the housing of the customer assembly (not shown) for return to the torque converter 18.

In another embodiment, the reed valve 42 can be replaced with a solenoid valve or other valve selectively openable to supply fluid from the torque converter 18 to the electric motor 14. In such an embodiment, a control system may be provided for controlling the valve based on certain parameters or operational characteristics such as electric motor temperature, input current, output torque, etc.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 MHT
14 Electric Motor
18 Torque Converter
22 Crankshaft
26 Rotor
28 Pump
29 Chamber
34 Output Shaft
35 Torque Converter Cover
40 Passageway
42 Reed Valve
44 Weld
48 Stator
F Fluid

1. A modular hybrid transmission comprising:
an electric motor;
a torque converter driven by the electric motor;
wherein the torque converter includes a pump and a cover defining a housing; and
wherein the housing of the torque converter includes a valve for selectively restricting or allowing a flow of fluid from the housing of the torque converter to the electric motor.

2. The modular hybrid transmission according to claim 1, wherein the valve includes a reed valve.

3. The modular hybrid transmission according to claim 2, wherein the reed valve is configured to open when a pressure inside the torque converter exceeds a threshold value.

4. The modular hybrid transmission according to claim 3, wherein the threshold value is within 30% of a maximum torque converter pressure.

5. The modular hybrid transmission according to claim 1, wherein the fluid is directed to a stator of the electric motor

6. The modular hybrid transmission according to claim 1, wherein the valve defines a flow passage extending at an oblique angle with respect to a rotational axis of the torque converter.

7. The modular hybrid transmission according to claim 1, wherein the valve restricts or allows the flow of fluid through the torque converter cover.

8. A torque converter for a modular hybrid transmission comprising:
a housing; and
a pump configured to be driven by an electric motor;
wherein the housing of the torque converter includes a reed valve for selectively restricting or allowing a flow of fluid from the torque converter to the electric motor;
wherein the valve includes a reed valve;
wherein the reed valve is configured to open when a pressure inside the torque converter exceeds a threshold value; and
wherein the threshold value is within 30% of a maximum torque converter pressure.

9. (canceled)

10. (canceled)

11. (canceled)

12. The torque converter according to claim 8, wherein the valve defines a flow passage extending at an oblique angle with respect to a rotational axis of the torque converter.

13. The torque converter according to claim 8, wherein the housing incudes a torque converter cover, and the valve restricts or allows the flow of fluid through the torque converter cover.

14. A method of cooling an electric motor of a modular hybrid transmission comprising:
providing a modular hybrid transmission comprising:
an electric motor;
a torque converter driven by the electric motor;
the torque converter including a pump and a cover defining a housing; and
wherein the housing of the torque converter includes a valve for selectively restricting or
allowing a flow of fluid from the housing to the electric motor;
operating the modular hybrid transmission to generate fluid pressure in the torque converter; and
supplying fluid from the housing of the torque converter to the electric motor via the valve based at least in part on an operational characteristic of the modular hybrid transmission.

15. The method according to claim 14, wherein the operational characteristic includes a fluid pressure within the torque converter.

16. The method according to claim 15, wherein the valve includes a reed valve configured to open when the pressure in the torque converter exceeds a threshold value.

17. The method according to claim 16, wherein the threshold value is within 30% of a maximum torque converter pressure.

18. The method according to claim 14, further comprising directing the fluid to a stator of the electric motor.

19. The method according to claim 14, wherein the valve defines a flow passage extending at an oblique angle with respect to a rotational axis of the torque converter.

20. The method according to claim 19, wherein the valve restricts or allows the flow of fluid through the torque converter cover.
